(19) United States
(12) Patent Application Publication
(10) Pub. No.: US 2026/0004814 A1
(43) Pub. Date: Jan. 1, 2026

(54) METHOD FOR RENDERING, STORAGE MEDIUM AND ELECTRONIC DEVICE

(71) Applicant: Beijing Zitiao Network Technology Co., Ltd., Beijing (CN)

(72) Inventor: Yanlong CHANG, Beijing (CN)

(21) Appl. No.: 19/257,114

(22) Filed: Jul. 1, 2025

(30) Foreign Application Priority Data
Jul. 1, 2024 (CN) 202410876193.0

(51) Int. Cl. G11B 27/031; G06F 3/0484; G06T 11/00

(52) U.S. Cl. CPC G11B 27/031; G06F 3/0484; G06T 11/001; G06T 2200/24

(57) ABSTRACT

The embodiments of the present disclosure relate to a method for rendering, a storage medium and an electronic device. And the method includes: displaying a video editing page, wherein the video editing page includes a preview area, and a preview image formed by a plurality of video materials is displayed in the preview area; in response to a selection operation on the video editing page, determining a to-be-edited video material and a non-editable video material; and rendering an image in the non-editable video material to obtain an intermediate texture; and in response to an editing operation on the to-be-edited video material, displaying an updated preview image in the preview area.

### CROSS-REFERENCE TO RELATED APPLICATION

The present application claims the priority and benefits of Chinese Patent Application No. 202410876193.0, filed on Jul. 1, 2024, which is incorporated herein by reference in its entirety as part of the present application.

### TECHNICAL FIELD

The embodiments of the present disclosure relate to a method for rendering, a storage medium and an electronic device.

### BACKGROUND

With the continuous development of Internet technology, video editing has become a common operation for many users. For example, video editing tools can be adopted to edit a plurality of materials, add effects and the like to generate a complete target video.

In the process of high-frequency editing operation by the video editing tool on the materials, in order to show the operation effect to the user, video pictures in the operation process will be displayed on the video editing tool. Due to the large number of materials processed, the rendering takes a long time, which affects the overall editing process of the video.

### SUMMARY

The present disclosure provides a method for rendering, an apparatus, a storage medium and an electronic device.

Embodiments of the present disclosure provide a method for rendering, and the method includes:
displaying a video editing page, in which the video editing page includes a preview area, and a preview image formed by a plurality of video materials is displayed in the preview area;
in response to a selection operation on the video editing page, determining a to-be-edited video material and a non-editable video material; and rendering an image in the non-editable video material to obtain an intermediate texture; and
in response to an editing operation on the to-be-edited video material, displaying an updated preview image in the preview area, in which the updated preview image is obtained by synthesizing and rendering based on the intermediate texture and the updated image of the to-be-edited video material, and the editing operation is used for updating a display state of the image in the to-be-edited video material to obtain the updated image.

Embodiments of the present disclosure also provide an apparatus for rendering, and the apparatus includes: a page display module, an intermediate texture generation module and a rendering module.

The page display module is configured to display a video editing page, in which the video editing page includes a preview area, and a preview image formed by a plurality of video materials is displayed in the preview area.

The intermediate texture generation module is configured to, in response to a selection operation on the video editing page, determine a to-be-edited video material and a non-editable video material; and render an image in the non-editable video material to obtain an intermediate texture; and

The rendering module is configured to, in response to an editing operation on the to-be-edited video material, display an updated preview image in the preview area, in which the updated preview image is obtained by synthesizing and render based on the intermediate texture and the updated image of the to-be-edited video material, and the edit operation is used for updating a display state of the image in the to-be-edited video material to obtain the updated image.

Embodiments of the present disclosure also provide an electronic device, and the electronic device includes:
one or more processors;
a storage apparatus configured to store one or more programs; and
in response to the one or more programs are executed by the one or more processors, the one or more processors implement the method for rendering as provided in any embodiment of the present disclosure.

Embodiments of the present disclosure further provide a non-transitory storage medium includes a computer-executable instruction, in which the computer-executable instruction is executed by a computer processor to implement the method for rendering as provided in any embodiment of the present disclosure.

### BRIEF DESCRIPTION OF DRAWINGS

The foregoing and other features, advantages, and aspects of embodiments of the present disclosure will become more apparent in conjunction with the accompanying drawings and with reference to the following specific embodiments. Throughout the accompanying drawings, the same or similar accompanying markings indicate the same or similar elements. It should be understood that the accompanying drawings are schematic and that the originals and elements are not necessarily drawn to scale.

FIG. 1 is a flow schematic diagram of a method for rendering provided by an embodiment of the present disclosure;

FIG. 2 is a schematic diagram of a video editing page provided by an embodiment of the present disclosure;

FIG. 3 is a schematic diagram of a hierarchical relationship of a plurality of layers on a canvas provided by an embodiment of the present disclosure;

FIG. 4 is a schematic diagram of an intermediate texture provided by an embodiment of the present disclosure;

FIG. 5 is a schematic diagram of an intermediate texture provided by an embodiment of the present disclosure;

FIG. 6 is a schematic diagram of an intermediate texture provided by an embodiment of the present disclosure;

FIG. 7 is a schematic diagram of an intermediate texture provided by an embodiment of the present disclosure;

FIG. 8 is a schematic diagram of a video editing page provided by an embodiment of the present disclosure;

FIG. 9 is a structural schematic diagram of an apparatus for rendering provided by the embodiment of the present disclosure; and

FIG. 10 is a structural schematic diagram of an electronic device provided by an embodiment of the present disclosure.

### DETAILED DESCRIPTION

Embodiments of the present disclosure will be described in greater detail below with reference to the accompanying drawings. Although certain embodiments of the present disclosure are shown in the accompanying drawings, it should be understood, however, that the present disclosure may be realized in various forms and should not be construed as being limited to the embodiments set forth herein, but rather are provided for a more thorough and complete understanding of the present disclosure. It should be understood that the accompanying drawings and embodiments of the present disclosure are for exemplary purposes only and are not intended to limit the scope of protection of the present disclosure.

It should be understood that the various steps documented in the method embodiments of the present disclosure may be performed in a different order, and/or in parallel. Furthermore, the method embodiments may include additional steps and/or omit performing the illustrated steps. The scope of the present disclosure is not limited in this regard.

The term “includes” and variations thereof, as used herein, is open-ended, i.e., “include but not limited to.” The term “based on” is “based at least in part on.” The term “one embodiment” means “at least one embodiment”; the term “another embodiment” means “at least one additional embodiment”; the term “another embodiment” means “at least one other embodiment.”; and the term “some embodiments” means “at least some embodiments”. Definitions of other terms will be given in the following description.

It should be noted that the concepts of “first”, “second” and the like mentioned in the present disclosure are only used to differentiate different apparatuses, modules or units, and are not used to define the order or interdependence of the functions performed by these apparatuses, modules or units.

It should be noted that the modifications of “one” and “more” mentioned in the present disclosure are schematic rather than limiting, and the person skilled in the art should understand that, unless otherwise expressly stated in the context, they should be understood as “one or more”. or plurality” unless the context clearly indicates otherwise.

The names of the messages or information interacting between the multiple apparatuses of the disclosure are used for illustrative purposes only and are not intended to limit the scope of those messages or information.

It is to be understood that before using the technical solutions disclosed in each embodiment of the present disclosure, it is needed to inform the user of the type, scope of use, and use scenarios of the personal information involved in the present disclosure and gain the user authorization through appropriate methods in accordance with relevant laws and regulations.

For example, in response to receiving an unsolicited request from the user, a prompting message is sent to the user to explicitly prompt the user that the operation requested to be performed will require access to and use of the user's personal information. Thereby, the user is enabled to independently choose, based on the prompting information, whether or not to provide the personal information to software or hardware, such as an electronic device, an application, a server, or a storage medium, that performs the operation of the technical solution of the present disclosure.

As an optional but non-limiting realization, in response to receiving an unsolicited request from the user, the manner of sending the prompting information to the user may be, for example, a pop-up window, in which the prompting information may be presented in the form of text. In addition, the pop-up window may contain an option control for the user to select “agree” or “disagree” to provide the personal information to the electronic device.

It is to be understood that the above notification and obtaining user authorization process is only schematic and does not constitute a limitation on the implementation of the present disclosure, and other ways to satisfy relevant laws and regulations may also be applied in the implementation of the present disclosure.

It is understood that the data involved in the present technical solution (including but not limited to the data itself, the acquisition or use of the data) should comply with the requirements of the corresponding laws and regulations and relevant provisions.

In a video editing process, a plurality of video materials can be edited, and the materials herein include but are not limited to videos, images, texts, effects and the like. The video materials are displayed through layers, and each layer is configured to display at least one video material. Different layers have different hierarchies, and the hierarchies of the layers represent a rendering sequence of the video materials on a canvas. For each timestamp, the corresponding content of the video material at the timestamp is displayed on the corresponding layer to form an image of the video material at the timestamp, and the corresponding images of the plurality of video materials at the timestamp can be rendered to obtain video frames corresponding to the timestamp. The rendering time periods of different video materials may be different, and exemplarily, the rendering time period of the video material corresponding to a layer 1 is 0-10 s, the rendering time period of the video material corresponding to a layer 2 is 0-20 s, and the rendering time period of the video material corresponding to a layer 3 is 0-15 s.

Because each video material corresponds to a plurality of video frames, in order to simplify the video editing process, an editing operation is carried out on the plurality of video materials in a freeze frame state, and editing operation on the whole materials is achieved. Exemplarily, position change is carried out on the image of the video material displayed in the layer 1 in the fifth frame in the freeze frame state, for example, the image is moved from a position A to a position B; and correspondingly, position change is carried out on the video material corresponding to the layer 1 in the whole rendering time period, namely, the image of the video displayed in the layer 1 in all the video frames is moved from the position A to the position B.

In the embodiment, the editing operation on the video materials can be an attribute change operation on the video materials; in the process of carrying out attribute change on a certain video material, a video picture displayed in a video editing tool is continuously refreshed; for example, the process of dragging to change the position of the image of the video material displayed in the layer 1 includes the change in a plurality of position points; different rendering refreshing is carried out in the process of changing the position of the image of the video material displayed in the layer 1; and each time of refreshing is carried out until obtaining a corresponding video frame picture of the image of the video material displayed in the layer 1 at a new position, namely, it is needed to render the video picture once in each time of refreshing, so as to display the real-time change of the video picture in process of changing the position of the image of the video material displayed in the layer 1, and the video picture displayed in the video editing tool is a preview image. By taking a case that the video includes three video materials and the three video materials are respectively rendered on three layers as an example, the layer 1, a layer 2 and a layer 3 respectively display the image of one video material. In each refreshing process, the following rendering steps are executed: clearing the canvas, rendering an image 1 of the video material corresponding to the layer 1, rendering an image 2 of the video material corresponding to the layer 2, rendering an image 3 of the video material corresponding to the layer 3, and ending refreshing. The more the video materials and/or the more the layers, the longer the time consumed by single refreshing is. In the high-frequency editing process of the video materials, the overall editing time consumption is correspondingly increased.

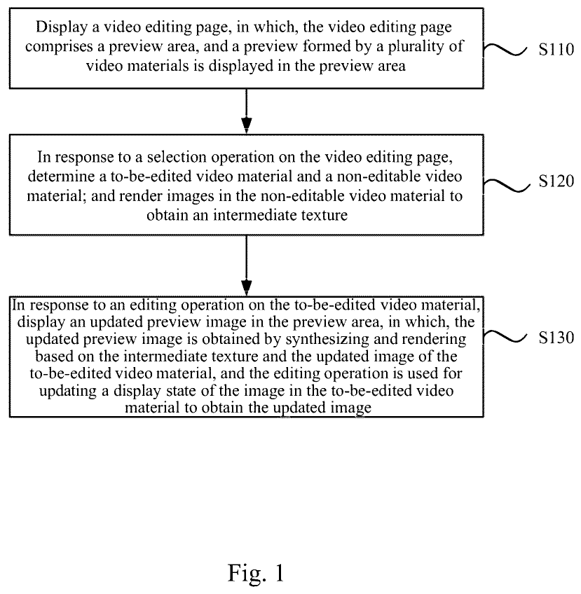

In order to solve the above technical problems, an embodiment of the present disclosure provides a method for rendering. As shown in FIG. 1, FIG. 1 is a flow schematic diagram of a method for rendering provided by an embodiment of the present disclosure. The embodiment of the present disclosure is suitable for processing images of a plurality of non-editable video materials to obtain a small number of intermediate textures during editing local video materials in the video editing process; in the process of forming the preview image, the rendering complexity of single rendering is reduced; the method can be implemented by an apparatus for rendering, and the apparatus can be realized in a form of software and/or hardware; optionally, the apparatus is realized through an electronic device; and the electronic device can be a mobile terminal, a PC terminal or a server and the like.

As shown in FIG. 1, the method includes:
S110, displaying a video editing page, in which, the video editing page includes a preview area, and a preview image formed by a plurality of video materials is displayed in the preview area;
S120, in response to a selection operation on the video editing page, determining a to-be-edited video material and a non-editable video material; and rendering an image in the non-editable video material to obtain an intermediate texture; and
S130, in response to an editing operation on the to-be-edited video material, displaying an updated preview image in the preview area, in which, the updated preview image is obtained by synthesizing and rendering based on the intermediate texture and the updated image of the to-be-edited video material, and the editing operation is used for updating a display state of the image in the to-be-edited video material to obtain the updated image.

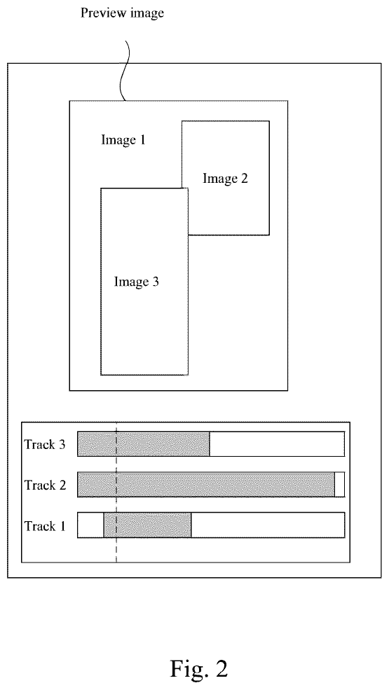

Exemplarily, as shown in FIG. 2, FIG. 2 is a schematic diagram of a video editing page provided by an embodiment of the present disclosure. The video editing page can be an operation page of the video editing tool; and the video editing page includes the preview area, and the preview area is configured to display the video picture of each video frame in to-be-edited video data, namely the preview image. The to-be-edited video shown in FIG. 2 is generated by editing three video materials, correspondingly, images corresponding to three layers are rendered on the canvas in sequence, and each layer is configured to display the content of one video material. The number of the layers in FIG. 2 is only one example, the actual number of the layers is determined according to the number of the video materials required by video editing, which is not limited here. One layer in FIG. 2 displays the content of one video material, and in other embodiments, one layer can display the content of a plurality of video materials, which is not limited here. The image 1, the image 2 and the image 3 in FIG. 2 are images in the three video materials respectively and can be distributed in different layers, and are sequentially rendered to obtain the preview image.

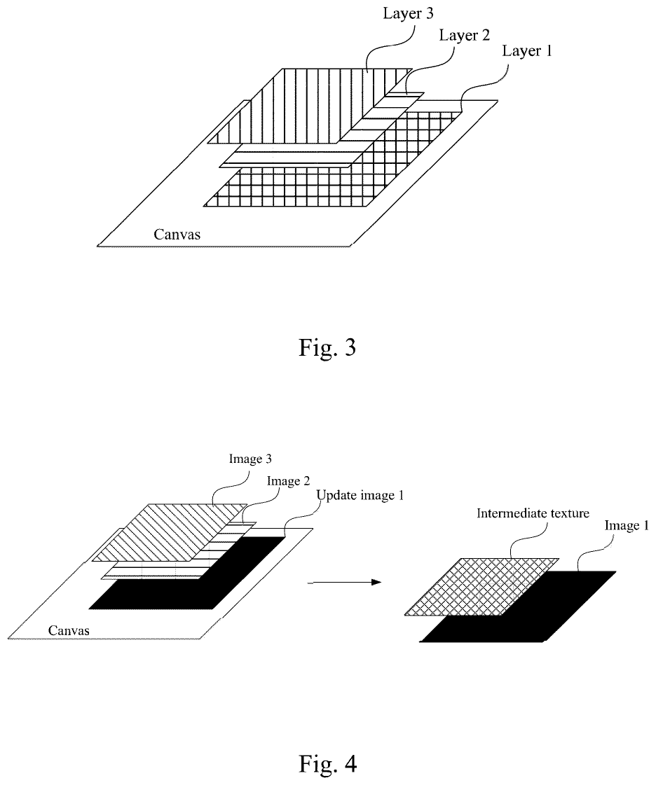

Exemplarily, as shown in FIG. 3, FIG. 3 is a schematic diagram of a hierarchical relationship of a plurality of layers on a canvas provided by an embodiment of the present disclosure. The hierarchy of the layer can represent the rendering sequence of the images of the video materials displayed in the layer on the canvas; by taking FIG. 3 as an example, the image 1 is at the layer 1, the image 2 is at the layer 2, the image 3 is at the layer 3, and the hierarchies of the layer 1, the layer 2 and the layer 3 are sequentially increased; and correspondingly, the rendering sequence of the images of the video materials are sequentially an image 1 of the video materials displayed by the layer 1, an image 2 of the video materials displayed by the layer 2, and an image 3 of the video materials displayed by the layer 3.

The video editing page further includes a track display area, the track display area includes a plurality of editing tracks, and each editing track corresponds to one video material; and exemplarily, with reference to FIG. 2, in FIG. 2, there are three editing tracks, each corresponding to one video material. The track display area further includes a time axis, and a plurality of editing tracks share one time axis so as to ensure that the video materials on the plurality of editing tracks are synchronous in time. A time slider is arranged on the time axis and configured to represent a corresponding time point of the image displayed in the preview area on the editing track. For example, a dotted line in the track display area in FIG. 2 is configured to represent a corresponding position of the position of time slider on the plurality of editing tracks. In FIG. 2, the material content corresponding to the dotted line in the track display area on the plurality of editing tracks is displayed in the preview area, the time information corresponding to the position of the time slider on the time axis is 10 s, and correspondingly, the material content corresponding to the dotted line of 10 s on each editing track is displayed in the preview area.

Optionally, in response to a trigger operation in the track display area, a freeze frame state is entered, and the trigger operation includes but is not limited to a click operation on a target time position on the time axis, a sliding operation on the time slider, a dragging operation on the dotted line corresponding to the time slider and the like. According to the trigger operation in the track display area, the corresponding time information of entering the freeze frame state is determined; the image corresponding to each video material is determined based on the time information corresponding to the freeze frame state on each editing track; the preview image is obtained based on image rendering of each video material; and the preview image is displayed in the preview area, and thus the initial content in the freeze frame state is formed. Taking FIG. 2 as an example, the preview image is formed through the images of the three video materials, in which, the image 1 is the image in the video material 1, the image 2 is the image in the video material 2, and the image 3 is the image in the video material 3.

The editing operation is carried out on the image of one or more video materials that form the preview image, so that the editing operation on the video materials is realized. The to-be-edited video material and the non-editable video material are determined in the plurality of video materials, the to-be-edited video material is video material which is needed to be edited, and the non-editable video material is the video material which is not needed to be edited. In different stages of video editing, the to-be-edited video material and the non-editable video material may be different and may be changed according to editing requirements of the video materials. Exemplarily, taking FIG. 2 as an example, firstly, a video material 1 is determined as the to-be-edited video material, and a video material 2 and a video material 3 are determined as the non-editable video materials. After the video material 1 is edited, the video material 2 is determined as the to-be-edited video material, and the video material 1 and the video material 3 are determined as the non-editable video materials.

The to-be-edited video material and the non-editable video material can be determined according to a selection operation in the video editing page. The selection operation is also configured to indicate the to-be-edited video material in the plurality of video materials, the video material selected by the selection operation is determined as the to-be-edited video material, and other video materials except the to-be-edited video material are determined as the non-editable video materials.

Optionally, the selection operation may be a selection operation on an image of at least one video material in the preview image in the preview area. The selection operation on the image in the preview area can be the click operation on at least one image in the preview area, and the video material corresponding to the image of the uppermost level at the click position is determined as the to-be-edited video material. It is to be understood that the images of the plurality of video materials are rendered in a layer form to form the preview image. The images of the plurality of video materials in the preview image displayed in the preview area are sequentially displayed in the layer form according to the rendering sequence; each layer can be selected; and the to-be-edited video material is determined based on the image of the video material corresponding to the selected layer.

The selection operation can also be a selection operation on at least one editing track in the track display area. The selection operation on the editing track can be the click operation on the editing track. The video material corresponding to the selected image in the preview area or the video material corresponding to the selected editing track is the to-be-edited video material, and there may be one or more to-be-edited video materials.

In the process of editing the to-be-edited video material, the display state of the image of the non-editable video material is not changed, and the display state of the image of the to-be-edited video material is updated. Moreover, in the editing process of the to-be-edited video material, the preview image displayed in the preview area is continuously refreshed; a new preview image is displayed in each refreshing; each preview image is obtained by carrying out rendering on the image of each non-editable video material and the updated image of the to-be-edited video material for one time; and by taking FIG. 2 as an example, in response to the video material 1 is the to-be-edited video material, it is needed to implement the rendering of the images of the three video materials in each refreshing process of the preview image. In order to reduce the rendering time consumption in the single refreshing rendering process, at least local images of the non-editable video material are combined to obtain the intermediate textures, and the number of the intermediate textures is smaller than or equal to that of the non-editable video material. Correspondingly, in the single refreshing rendering process, the rendering time consumption of the intermediate textures is smaller than or equal to that of the non-editable video material, and thus the time consumption of single refreshing rendering is reduced; in the high-frequency editing process of the to-be-edited video material, the corresponding preview images in the plurality of editing processes are displayed, so that the total rendering time consumption of the to-be-edited video material is reduced in the rendering process of the preview images, and the video editing efficiency is improved.

In some embodiments, a plurality of non-editable video materials are provided, and the images of the plurality of non-editable video materials are combined to obtain an intermediate texture; in some embodiments, the plurality of non-editable video materials are split into at least two non-editable video material groups, each non-editable video material group includes at least one non-editable video material, and one intermediate texture is generated based on the at least one non-editable video material in each non-editable video material group. Taking FIG. 3 as an example, the video material 1 is the to-be-edited video material, the video material 2 and the video material 2 are non-editable video materials, the images (namely the image 2 and the image 3) of the non-editable video materials are combined to obtain an intermediate texture; correspondingly, in the process of editing the to-be-edited video material, the preview image is refreshed in real time; in the single-time refreshing rendering process of the preview image, one-time refreshing rendering is implemented by rendering the updated image of the to-be-edited video material and the intermediate texture; and compared with the sequential rendering process of the images of the three video materials in sequence, the number of rendering times is reduced, and the effect of reducing the time consumption of single-time rendering is achieved. It is to be understood that the three video materials in FIG. 3 are only examples, in other embodiments, the number of the video materials is increased, for example, in response to the number of the video materials is 10, the video material 1 is the to-be-edited video material, the video materials 2 to 10 are the non-editable video materials, the images corresponding to the video materials 2 to 10 are combined to obtain an intermediate texture; correspondingly, in the single-time refreshing rendering process, original rendering on the images of the 10 video materials is converted into rendering on the updated image of the video material 1 and the intermediate texture, and the time consumption of single-time refreshing rendering is obviously reduced. It is to be understood that the updated image of the to-be-edited video material is obtained by editing the original image of the to-be-edited video material.

Optionally, the combination mode of the non-editable video materials is determined based on the information of the layers with the to-be-edited video materials and the non-editable video materials, and the information of the layer with the video materials may be the hierarchy information of layer with the video materials. In response to the information of the layer on which the to-be-edited video material is located is the minimum hierarchy or the maximum hierarchy, the information of the layers with the plurality of non-editable video materials is continuous, and the images of the plurality of non-editable video materials are combined into an intermediate texture. By taking FIG. 3 as an example, the video material 1 is the to-be-edited video material, namely, the information of the layer on which the to-be-edited video material is located is the minimum hierarchy, editing operation is carried out on the image 1 in the video material 1, and the images (namely, the image 2 and the image 3) of the to-be-edited video material are combined into an intermediate texture; and the video material 3 is the to-be-edited video material, namely, the information of the layer on which the to-be-edited video material is located is the maximum hierarchy, and the images (namely, the image 1 and the image 2) of the to-be-edited video material are combined into an intermediate texture. The images respectively corresponding to the to-be-edited video material and the non-editable video material here are respectively the images corresponding to the to-be-edited video material and the non-editable video material in the freeze frame state, or the images respectively corresponding to the to-be-edited video material and the non-editable video material in a certain timestamp.

In response to the layer on which the to-be-edited video material is located is among the layers with the plurality of non-editable video materials, namely, the information of the layer on which the to-be-edited video material is located is smaller than the information of the layer with part of the non-editable video materials and larger than the information of the layer with part of the non-editable video materials, the plurality of non-editable video materials are grouped, and an intermediate texture is generated by the image of the non-editable video materials in each non-editable video material group. By taking FIG. 3 as an example, in response to the video material 2 is the to-be-edited video material, the image 2 is edited; the video material 1 and the video material 3 are non-editable video materials, the layer 2 of the video material 2 is between the layer 1 with the video material 1 and the layer 3 with the video material 3, one intermediate texture is generated based on the image 1 of the video material 1, and one intermediate texture is generated based on the image 3 of the video material 3.

Optionally, generating the intermediate texture based on the textures of the non-editable video materials includes: obtaining the information of the layer on which each video material is located, and grouping the non-editable video materials based on the information of the layer on which the to-be-edited video material is located to obtain at least one non-editable video material group, each non-editable video material group including at least one non-editable video material at the continuous layers; and generating one intermediate texture based on the image of at least one non-editable video material in each non-editable video material group. Specifically, sorting is performed based on the information of the layer with the video materials, the to-be-edited video material is treated as a division node of grouping, and at least one non-editable video material corresponding to the continuous layers can form a non-editable video material group based on the division node. Exemplarily, the information of the layer with the video materials is the layer 1, the layer 2, the layer 3, a layer 4 and a layer 5 respectively; in response to the information of the layer on which the to-be-edited video material is located is the layer 1, the information of the layers of the non-editable video materials is the layer 2, the layer 3, the layer 4 and the layer 5 respectively, and the information of the layers of the non-editable video materials is continuous layer information, the plurality of non-editable video materials are divided into a non-editable video material group. In response to the information of the layer on which the to-be-edited video material is located is the layer 3, the layer information is the non-editable video materials of the layer 1 and the layer 2, and one non-editable video group can be formed; and the layer information is the non-editable video materials of the layer 4 and the layer 5, and another non-editable video material group is formed. In response to the information of the layer on which the to-be-edited video material is located is the layer 1 and the layer 3, the layer information of the non-editable video materials with the layer information as the layer 2 and the layer information of other non-editable video materials are discontinuous, the non-editable video materials with the layer information as the layer 2 form a non-editable video material group; and the non-editable video materials with the layer information as the layer 4 and the layer 5 form a non-editable video material group.

Each non-editable video material group includes one or more non-editable video materials, and one intermediate texture is generated by the image of the one or more non-editable video materials in one non-editable video material group. Optionally, generating one intermediate texture based on the textures of at least one non-editable video material in each non-editable video material group includes: in response to the non-editable video material group includes at least two non-editable video materials, combining the images of the at least two non-editable video materials to obtain the intermediate texture corresponding to the non-editable video material group; and in response to the non-editable video material group includes one non-editable video material, determining the image of the non-editable video material as the intermediate texture.

The combination processing for the images of the at least two non-editable video materials can include: determining a combination sequence of the non-editable video materials based on the layer information of the at least two non-editable video materials. By taking FIG. 3 as an example, the smaller the layer information of the non-editable video materials is, the higher the combination sequence is. In the image combination process, based on the combination sequence of the non-editable video materials, the images of the non-editable video materials in the next sequence sequentially cover the images of the non-editable video materials in the previous sequence, and thus the intermediate texture is obtained. For example, the layer information in the non-editable video material group is the layer 1, the layer 2 and the layer 3 respectively; the size and the position of the image of each non-editable video material are different; and the image corresponding to the layer 2 covers at least part of the image corresponding to the layer 1 to obtain a texture in combining, and the image corresponding to the layer 3 covers at least part of the image of the texture in combining to obtain the intermediate texture corresponding to the non-editable video material group. The distance from the layer to the canvas affects the sequence of the image here, for example, the distance from the layer 1 to the canvas is minimum, the layer 1 is the first layer rendered, and so on; and correspondingly, the combination sequence of each image is determined based on the hierarchical information of the layers.

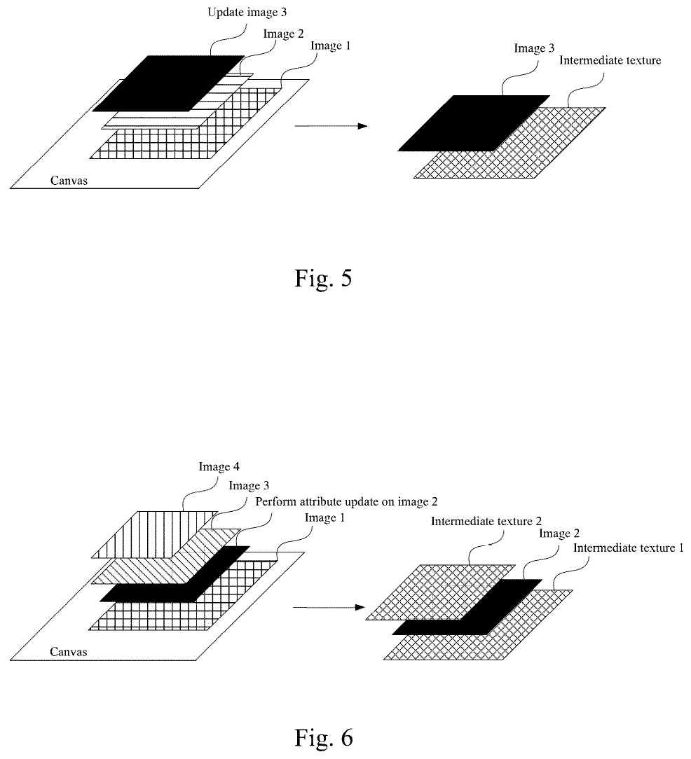

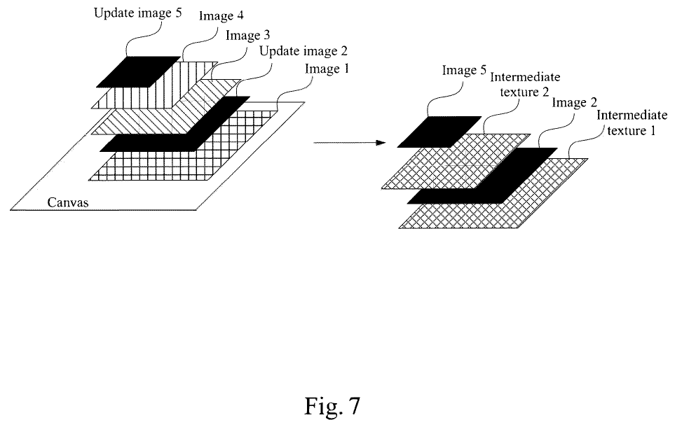

Exemplarily, with reference to FIG. 4 to FIG. 7, FIG. 4 to FIG. 7 are schematic diagrams of a plurality of intermediate textures provided by an embodiment of the present disclosure. In FIG. 4, the layer information of the to-be-edited video material is the layer 3, and the image 1 and the image 2 are combined into the intermediate texture; in FIG. 5, the layer information of the to-be-edited video material is the layer 1, and the image 2 and the image 3 are combined into the intermediate texture. In FIG. 6, the layer information of the to-be-edited video material is the layer 2, the non-editable video materials are divided into two non-editable video material groups, the image 1 serves as the intermediate texture 1, and the image 3 and the image 4 are combined into an intermediate texture 2. In FIG. 7, the layer information of the to-be-edited video material is the layer 2 and the layer 5, the non-editable video materials are divided into two non-editable video material groups, the image 1 serves as the intermediate texture 1, and the image 3 and the image 4 are combined into the intermediate texture 2. In FIG. 4 to FIG. 7, the number of the intermediate textures is smaller than that of the non-editable video materials; compared with a situation that the image corresponding to each video material is rendered in the single-time refreshing rendering process, the images of the non-editable video materials are processed into the intermediate textures, thus the number of rendering times in the single-time refreshing rendering process is reduced, and the time consumed for single-time refreshing rendering is further decreased.

In the attribute updating process of the to-be-edited video material, there are a plurality of times of refreshing rendering; it is needed to render the intermediate textures in each time of refreshing rendering; and in order to reduce unnecessary computation power consumption, after generating the intermediate textures based on the images of the non-editable video materials, the method further includes: caching the intermediate texture. The cached intermediate textures are read in each time of refreshing rendering, and thus the reusability of the intermediate textures is improved.

In the embodiment, the materials used for generating videos are stored in a CPU, and the rendering process is executed through a GPU; and optionally, the intermediate textures are cached in the GPU, on the basis of improving the reusability of the intermediate textures, the transmission process of the intermediate textures between the CPU and the GPU is omitted, and thus the rendering efficiency of the intermediate textures is improved.

It is to be understood that the intermediate textures are textures generated and rendered in the editing process of the to-be-edited video materials; in response to the to-be-edited video materials and the non-editable video materials are changed, the cached intermediate textures will be deleted, and new intermediate textures will be determined again based on the changed to-be-edited video materials and non-editable video materials. By taking FIG. 3 as an example, in response to the video material 1 is the to-be-edited video material, the intermediate texture 1 is generated based on the images of the video material 2 and the video material 3; the selection operation is inputted again, and in response to the video material 3 is selected as the new to-be-edited video material, the cached intermediate texture 1 is deleted, the intermediate texture 2 is generated based on the images of the video material 1 and the image layer 2, and the intermediate texture 2 is cached.

In the embodiment, in response to the to-be-edited video materials and the non-editable video materials are determined based on the selection operation, it is triggered to generate the intermediate texture, and the intermediate texture is cached, so that the cached intermediate texture can be read conveniently during multiple refreshing rendering on the subsequent attribute change process of the to-be-edited video material, and the rendering efficiency is improved.

The editing operation on the to-be-edited video material is an operation for updating the display state of the image in the to-be-edited video material, and the display state of the image can be updated by adjusting the attributes of the to-be-edited video material. The attributes of the to-be-edited video material include but are not limited to positions, rotation angles, sizes, brightness, transparency, colors and the like. The attributes of the to-be-edited video material are determined according to the types of the materials corresponding to the to-be-edited video material; and for different the types of the materials corresponding to the to-be-edited video material, the attributes of the to-be-edited video material are different. For example, in response to the material corresponding to the to-be-edited video material is a text, the attributes of the to-be-edited video material include but are not limited to font types, font sizes, font colors, positions and the like. In response to the material corresponding to the to-be-edited video material is a video, the attributes of the to-be-edited video material include but are not limited to rotation angles, sizes, brightness, transparency and the like.

In some embodiments, the editing operation includes a first editing operation on the image in the to-be-edited video material in the preview area, in which, the first editing operation includes but is not limited to a position editing operation, a rotation angle editing operation, a zooming operation and the like on the image in the to-be-edited video material. The position editing operation can be a dragging operation on the image in the to-be-edited video material, which changes the position of the image in the to-be-edited video material; the rotation angle editing operation can be a rotation operation on the image in the to-be-edited video material, which changes the rotation angle of the image in the to-be-edited video material; and the zooming operation can be a zooming-out operation or a zooming-in operation on the image in the to-be-edited video material, which changes the size of the image in the to-be-edited video material.

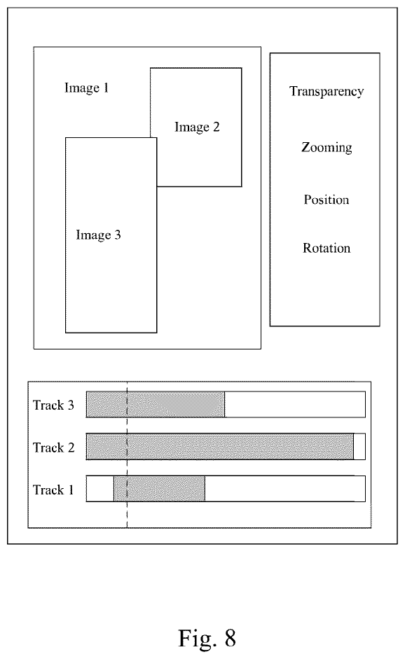

In some embodiments, the video editing page further includes an attribute setting area, and the attribute setting area includes a plurality of attribute setting controls; with reference to FIG. 8, FIG. 8 is a schematic diagram of a video editing page provided by an embodiment of the present disclosure. The attribute setting area can be displayed in response to a preset trigger operation, for example, the preset trigger operation can be a trigger operation on a setting control, or a preset gesture operation and the like.

It is to be understood that attribute setting controls in the attribute setting area in FIG. 8 are only examples, and the types and the number of the attribute setting controls are determined according to the types of the materials corresponding to the to-be-edited video materials. The attribute setting control can be a sliding control, a pull-down menu or an input control and the like. Correspondingly, the editing operation can also be a second editing operation on any attribute setting control in the attribute setting area. The second editing operation is configured to indicate the changed attribute value and can be an attribute value setting operation on any attribute setting control.

Exemplarily, by taking the brightness serving as the attribute as an example, the attribute setting control corresponding to the brightness can be the sliding control, the numerical range of the sliding control is a brightness range, and the second editing operation can be a sliding operation on a sliding block on the sliding control. Exemplarily, by taking a video style serving as the attribute as an example, the attribute setting control corresponding to the video style can be the pull-down menu, the pull-down menu includes a plurality of selectable video styles, and the second editing operation can be a selection operation on any video style. By taking the rotation angle serving as the attribute as an example, the attribute setting control corresponding to the rotation angle can be the input control, and the second editing operation can be an input operation on the rotation angle. The type and the specific form of the attribute setting control are not limited here.

In response to the received editing operation on the to-be-edited video material, the updated image of the to-be-edited video material is obtained, and the cached intermediate textures are read; and based on the rendering sequence of the updated image of the to-be-edited video material and the intermediate texture, the updated image of the to-be-edited video material and the intermediate texture are rendered in the preview area in sequence. By taking FIG. 4 as an example, the video material 3 is the to-be-edited video material, attribute updating is performed on the image 3 in the video material 3 based on an editing operation so as to obtain an updated image 3 (namely the updated image); the updated image 3 and a pre-cached intermediate texture are rendered; the rendering sequence of the intermediate texture is prior to the rendering sequence of the image 3; the intermediate texture is rendered on the canvas, and then the updated image 3 is rendered, thus completing refreshing rendering. By taking FIG. 5 as an example, the video material 1 is the to-be-edited video material, the rendering sequence of the image 1 is prior to the rendering sequence of the intermediate texture; the updated image 1 is obtained; the pre-cached intermediate texture is read; the updated image 1 is rendered on the canvas; and then the intermediate texture is rendered, thus completing refreshing rendering. By taking FIG. 7 as an example, the rendering sequence is the intermediate texture 1, the image 2, the intermediate texture 2 and the image 5; correspondingly, the updated image 2 and the updated image 5 are obtained; the pre-cached intermediate texture 1 and the pre-cached intermediate texture 2 are read; and the intermediate texture 1, the updated image 2, the intermediate texture 2 and the updated image 5 are rendered on the canvas in sequence to complete refreshing rendering.

The rendering sequence of the to-be-edited video material and the intermediate texture is determined based on the information of the layer on which the to-be-edited video material is located and the information of the layer with non-editable video material, and the rendering sequence of the intermediate texture is determined based on the information of the layer with the images that generate the intermediate texture. In response to the layer information of the non-editable video materials that generate the intermediate texture is smaller than the layer information of a certain to-be-edited video material, the rendering sequence of the intermediate texture is prior to the rendering sequence of the updated image of the to-be-edited video material. In response to the layer information of the non-editable video materials that generate the intermediate texture is greater than the layer information of a certain to-be-edited video material, the rendering sequence of the intermediate texture is after the rendering sequence of the updated image of the to-be-edited video material. Exemplarily, by taking FIG. 7 as an example, the layer information of the non-editable video material that generate the intermediate texture 1 is the layer 1, the hierarchy of the layer 1 is smaller than that of the layer 2 (the information of the layer with a certain to-be-edited video material), the rendering sequence of the intermediate texture 1 is prior to the rendering sequence of the updated image 2 (the updated image of the to-be-edited video material), the information of the image of the non-editable video material that generates the intermediate texture 2 is the layer 3 and the layer 4, the hierarchy of the layer 3 and the hierarchy of the layer 4 are both larger than that of the layer 2 and both smaller than that of the layer 5 (the information of the layer with the other to-be-edited video material); and correspondingly, the rendering sequence of the intermediate texture 2 is between the rendering sequence of the updated image 2 and the rendering sequence of the updated image 5 (the updated image of the other to-be-edited video material).

On the basis of the above embodiment, the images of the plurality of video materials are rendered on the canvas to form the preview image; and before rendering the updated image of the to-be-edited video material and the intermediate texture in sequence, the method further includes: clearing the canvas. By clearing the canvas, the interference of the rendered texture on the canvas on the next refreshing rendering process is avoided.

Optionally, whether the image of at least one video material can cover the canvas or not is determined, and in response to yes, the canvas does not need to be emptied. Optionally, in response to preset color data are set on the canvas, the canvas will be emptied before the updated image of the to-be-edited video material and the intermediate texture are rendered, so that the interference of the rendered texture on the preset color data on the canvas is avoided.

On the basis of the above embodiment, the editing operation includes a single editing operation and a continuous editing operation; the single editing operation can be understood as an editing operation which can be completed by one-time refreshing rendering, for example, an original rotation angle of the to-be-edited video material is 90°, the rotation angle after updating inputted through the editing operation is 180°, correspondingly, the image with the rotation angle of 180° is obtained, namely the updated image; the updated image of the to-be-edited video material and the intermediate texture are rendered in the preview area, and thus the change in the rotation angle of the to-be-edited video material is completed.

In the process of inputting the continuous editing operation, the attribute value of the to-be-edited video material continuously changes, and the attribute change process of the to-be-edited video material needs to be refreshed, rendered and displayed for a plurality of times. By taking the continuous editing operation as the dragging operation on the image of the to-be-edited video material as an example, the dragging operation is configured to update the position of the image of the to-be-edited video material in the preview image; in the dragging process of the image of the to-be-edited video material, the position of the image in the to-be-edited video material in the preview area continuously changes, and different positions of the image in the to-be-edited video material can be displayed through the preview image obtained through each time of refreshing. The continuous editing operation can also include: sliding the sliding control to update the brightness, transparency and other attributes of the image in the to-be-edited video material. The changed attribute can be recorded as a change attribute.

Optionally, in the response process of the continuous editing operation, for a plurality of attribute values of the change attribute corresponding to the continuous editing operation in the updating process, the preview images corresponding to the plurality of attribute values are sequentially displayed in the preview area; the generation mode of each preview image includes: obtaining a current attribute value of the change attribute in the updating process, and determining the updated image corresponding to the current attribute value; and synthesizing and rendering based on the updated image corresponding to the current attribute value and the intermediate texture to obtain the preview image corresponding to the current attribute value.

For any change attribute, such as positions, brightness and transparency, a plurality of attribute values are determined according to change granularity of the change attribute. The change granularity can be the unit change amount of the change attribute. By taking the transparency as an example, in response to the original transparency is 50%, the change granularity is 1%, and the transparency is increased through editing operation, the attribute values of the transparency can be refreshed to be 51%, 52%, 53% and the like in sequence. For each attribute value, the updated image corresponding to the current attribute value is obtained, for example, on the basis of an original image, the attribute value of the original image is adjusted to be the current attribute value, thus the updated image is obtained, and the original image can be the original image in the to-be-edited video material or a previous updated image obtained through previous attribute updating.

The updated image corresponding to the current attribute value and the intermediate texture are rendered in sequence to obtain the preview image corresponding to the current attribute value. The images are previewed for the plurality of attribute values in sequence in the preview area; a change video picture corresponding to the continuous change process of the attribute values is dynamically displayed, and thus the influence of change attributes on the video picture can be displayed to a video editing user.

According to the technical solution of the embodiment of the present disclosure, the to-be-edited video materials and the non-editable video materials are determined through the selection operation, a number of intermediate textures are generated based on the images of the non-editable video materials, and the number of the intermediate textures is smaller than or equal to that of the non-editable video materials, so that in response to the preview image is refreshed in the editing process of the to-be-edited video materials, the intermediate textures with a small number are reused; the updated images of the to-be-edited video materials and the intermediate textures are rendered to obtain the preview images, and therefore the reusability of the intermediate textures is improved on the basis of reducing the time consumed by single-time refreshing rendering.

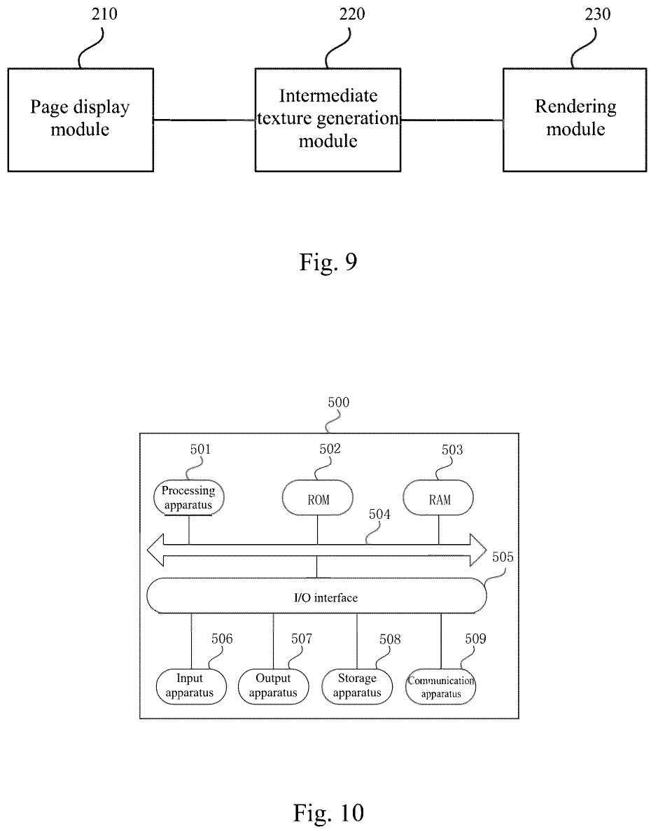

FIG. 9 is a structural schematic diagram of an apparatus for rendering provided by an embodiment of the present disclosure, as show in FIG. 9, the apparatus includes: a page display module 210, an intermediate generation module 220 and a rendering module 230.

The page rendering module 210 is configured to display a video editing page, in which, the video editing page includes a preview area, and a plurality of video materials are displayed in the preview area, and each layer displays one video material;

the intermediate texture generation module 220 is configured to: in a freeze frame state, in response to a selection operation on the video editing page, determine a to-be-edited video material and a non-editable video material, generate an intermediate texture based on the textures of the non-editable video material, and cache the intermediate texture, in which, the number of the intermediate textures is smaller than or equal to that of the non-editable video materials; and

the rendering module 230 is configured to: in response to an editing operation on the to-be-edited video material, render the updated to-be-edited video material and the intermediate texture in the preview area.

According to the technical solution provided by the embodiment of the present disclosure, the to-be-edited video materials and the non-editable video materials are determined through the selection operation, a number of intermediate textures are generated based on the images of the non-editable video materials, and the number of the intermediate textures is smaller than or equal to that of the non-editable video materials, so that in response to the preview image is refreshed in the editing process of the to-be-edited video materials, the intermediate textures with a small number are reused; the updated images of the to-be-edited video materials and the intermediate textures are rendered to obtain the preview images, and therefore the reusability of the intermediate textures is improved on the basis of reducing the time consumed by single-time refreshing rendering.

On the basis of the above embodiment, optionally, the intermediate texture generation module 220 is configured to: obtain the information of the layer on which each video material is located; group the non-editable video materials based on the information of the layer on which the to-be-edited video material is located to obtain at least one non-editable video material group, each non-editable video material group including at least one non-editable video material at the continuous layers; and generate an intermediate texture based on the image of at least one non-editable video material in each non-editable video material group.

Optionally, the intermediate generation module 220 is further configured to: in response to the non-editable video material group includes at least two non-editable video materials, combine the images of the at least two non-editable video materials to obtain the intermediate texture corresponding to the non-editable video material group; and in response to the non-editable video material group includes one non-editable video material, determine the image of the non-editable video material as the intermediate texture.

Optionally, the intermediate texture generation module 220 is further configured to: cache the intermediate texture.

On the basis of the above embodiment, optionally, the rendering module 230 is configured to: read the cached intermediate texture, and obtain the updated image of the to-be-edited video material; and based on the rendering sequence of the updated image of the to-be-edited video material and the intermediate texture, render the updated image of the to-be-edited video material and the intermediate texture in the preview area in sequence.

Optionally, the rendering sequence of the updated image of the to-be-edited video material and the intermediate texture is determined based on the information of the layer on which the to-be-edited video material is located and the information of the layer on which the non-editable video material is located.

Optionally, the images of the plurality of video materials are rendered on a canvas; and

the rendering module 230 is further configured to: before rendering the updated image of the to-be-edited video material and the intermediate texture in sequence, clear the canvas.

On the basis of the above embodiment, optionally, the video editing page further includes a track display area, the track display area includes a plurality of editing tracks, and each editing track corresponds to one video material.

The selection operation includes at least one selected from the group consisting of: a selection operation on an image of at least one video material in the preview image in the preview area; and a selection operation on at least one editing track in the track display area; in which, the video material corresponding to the selected image or the selected editing track is the to-be-edited video material, and the video material except the to-be-edited video material is the non-editable video materials.

On the basis of the above embodiment, optionally, the video editing page further includes an attribute setting area, and the attribute setting area includes a plurality of attribute setting controls; and
the editing operation includes at least one selected from the group consisting of: a first editing operation on the image in the to-be-edited video material in the preview area; and a second editing operation on any attribute setting control in the attribute setting area.

Optionally, the editing operation includes a single editing operation and a continuous editing operation;
the rendering module 230 is further configured to: in the response process of the continuous editing operation, for a plurality of attribute values of the change attribute corresponding to the continuous editing operation in the updating process, sequentially display the preview images corresponding to the plurality of attribute values; the generation mode of each preview image includes: obtaining a current attribute value of the change attribute in the updating process, and determining the updated image corresponding to the current attribute value; and synthesizing and rendering based on the updated image corresponding to the current attribute value and the intermediate texture to obtain the preview image corresponding to the current attribute value.

The apparatus for rendering provided by the embodiment of the present disclosure can execute the method for rendering provided by any embodiment of the present disclosure, and has corresponding functional modules and beneficial effects for executing the method.

It is to be noted that each unit and module included in the above-mentioned apparatus are only divided according to the functional logic, but are not limited to the above-mentioned division, as long as the corresponding function can be realized; and in addition, the specific names of each functional unit are only for the convenience of distinguishing them from each other and are not used for limiting the scope of protection of the embodiments of the present disclosure.

FIG. 10 is a structural schematic diagram of an electronic device provided by an embodiment of the present disclosure. Reference is made below to FIG. 10, which illustrates a schematic diagram of a structure of an electronic device (e.g., the terminal device or server of FIG. 10) 500 suitable for use in implementing embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 10 is merely an example, and should not pose any limitation to the functions and the range of use of the embodiments of the present disclosure.

As illustrated in FIG. 10, the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected by means of a bus 504. An input/output (I/O) interface 505 is also connected to the bus 504.

Usually, the following apparatus may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 5 illustrates the electronic device 500 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

The names of the messages or information interacted with between the plurality of apparatuses of the presently disclosed embodiments are used for illustrative purposes only and are not intended to place limitations on the scope of those messages or information.

An electronic device provided by the embodiment of the present embodiment and the method for rendering provided by the above embodiment belong to the same invention idea, and the technical details not described in detail in the present embodiment can be referred to the above embodiment, and the present embodiment has the same beneficial effect as the above embodiment.

An embodiment of the present disclosure provides a computer storage medium thereon a computer program is stored, and the program is executed by a process to execute the method for rendering provided by the embodiment.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device.

The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: display a video editing page, where the video editing page includes a preview area, and a preview image formed by a plurality of video materials is displayed in the preview area; in response to a selection operation on the video editing page, determine a to-be-edited video material and a non-editable video material; and render an image in the non-editable video material to obtain an intermediate texture; and in response to an editing operation on the to-be-edited video material, display an updated preview image in the preview area, where the updated preview image is obtained by synthesizing and rendering based on the intermediate texture and the updated image of the to-be-edited video material, and the edit operation is used for updating a display state of the image in the to-be-edited video material to obtain the updated image.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, a first acquisition unit can also be described as a “unit for obtaining at least two internet protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A method for rendering, comprising:
displaying a video editing page, wherein the video editing page comprises a preview area, and a preview image formed by a plurality of video materials is displayed in the preview area;
in response to a selection operation on the video editing page, determining a to-be-edited video material and a non-editable video material; and rendering an image in the non-editable video material to obtain an intermediate texture; and
in response to an editing operation on the to-be-edited video material, displaying an updated preview image in the preview area, wherein the updated preview image is obtained by synthesizing and rendering based on the intermediate texture and the updated image of the to-be-edited video material, and the editing operation is used for updating a display state of the image in the to-be-edited video material to obtain the updated image.

2. The method according to claim 1, wherein the rendering an image in the non-editable video material to obtain an intermediate texture, comprises:
obtaining information of a layer on which each video material is located;
grouping the non-editable video material based on information of a layer on which the to-be-edited video material is located to obtain at least one non-editable video material group, each non-editable video material group comprising at least one non-editable video material located on continuous layers; and
respectively generating the intermediate texture based on an image of at least one non-editable video material in each non-editable video material group.

3. The method according to claim 2, wherein the respectively generating the intermediate texture based on an image of at least one non-editable video material in each non-editable video material group, comprises:
in response to the non-editable video material group comprising at least two non-editable video materials, combining images of the at least two non-editable video materials to obtain an intermediate texture corresponding to the non-editable video material group; and
in response to the non-editable video material group comprising one non-editable video material, determining an image of the non-editable video material as the intermediate texture.

4. The method according to claim 1, wherein after the rendering an image in the non-editable video material to obtain an intermediate texture, the method further comprises: caching the intermediate texture.

5. The method according to claim 4, wherein a method of rendering the updated preview image, comprises:
reading the cached intermediate texture, and obtaining an updated image of the to-be-edited video material; and
based on a rendering sequence of the updated image of the to-be-edited video material and the intermediate texture, rendering the updated image of the to-be-edited video material and the intermediate texture in sequence to obtain the updated preview image.

6. The method according to claim 5, wherein the rendering sequence of the updated image of the to-be-edited video material and the intermediate texture is determined based on information of a layer on which the to-be-edited video material is located and information of a layer on which the non-editable video material is located.

7. The method according to claim 5, wherein images of the plurality of video materials are rendered on a canvas; and
before rendering the updated image of the to-be-edited video material and the intermediate texture in sequence, the method further comprises: clearing the canvas.

8. The method according to claim 1, wherein the video editing page further comprises a track display area, the track display area comprises a plurality of editing tracks, and the plurality of editing tracks respectively correspond to the plurality of video materials;
the selection operation comprises at least one selected from the group consisting of:
a selection operation on an image of at least one video material in the preview image in the preview area; and
a selection operation on at least one editing track in the track display area; and
a video material corresponding to the selected image or the selected editing track is the to-be-edited video material, and a video material except the to-be-edited video material is the non-editable video material.

9. The method according to claim 1, wherein the video editing page further comprises an attribute setting area, and the attribute setting area comprises a plurality of attribute setting controls; and
the editing operation comprises at least one selected from the group consisting of:
a first editing operation on an image of the to-be-edited video material in the preview area; and
a second editing operation on any attribute setting control in the attribute setting area.

10. The method according to claim 1, wherein the editing operation comprises a single editing operation and a continuous editing operation;
the displaying an updated preview image in the preview area, comprises:
in a response process of the continuous editing operation, for a plurality of attribute values of change attributes corresponding to the continuous editing operation in an updating process, sequentially displaying preview images corresponding to the plurality of attribute values; and
wherein a generation mode of each preview image comprises:
obtaining a current attribute value of the change attribute in the updating process, and determining an updated image corresponding to the current attribute value; and
synthesizing and rendering based on the updated image corresponding to the current attribute value and the intermediate texture to obtain a preview image corresponding to the current attribute value.

11. An electronic device, comprising:
one or more processors; and
a storage apparatus configured to store one or more programs; and
in response to the one or more programs are executed by the one or more processors, the one or more processors implement a method for rendering, wherein the method comprises:
displaying a video editing page, wherein the video editing page comprises a preview area, and a preview image formed by a plurality of video materials is displayed in the preview area;
in response to a selection operation on the video editing page, determining a to-be-edited video material and a non-editable video material; and rendering an image in the non-editable video material to obtain an intermediate texture; and
in response to an editing operation on the to-be-edited video material, displaying an updated preview image in the preview area, wherein the updated preview image is obtained by synthesizing and rendering based on the intermediate texture and the updated image of the to-be-edited video material, and the editing operation is used for updating a display state of the image in the to-be-edited video material to obtain the updated image.

12. The electronic device according to claim 11, wherein the rendering an image in the non-editable video material to obtain an intermediate texture, comprises:
obtaining information of a layer on which each video material is located;
grouping the non-editable video material based on information of a layer on which the to-be-edited video material is located to obtain at least one non-editable video material group, each non-editable video material group comprising at least one non-editable video material located on continuous layers; and
respectively generating the intermediate texture based on an image of at least one non-editable video material in each non-editable video material group.

13. The electronic device according to claim 12, wherein the respectively generating the intermediate texture based on an image of at least one non-editable video material in each non-editable video material group, comprises:
in response to the non-editable video material group comprising at least two non-editable video materials, combining images of the at least two non-editable video materials to obtain an intermediate texture corresponding to the non-editable video material group; and
in response to the non-editable video material group comprising one non-editable video material, determining an image of the non-editable video material as the intermediate texture.

14. The electronic device according to claim 11, wherein after the rendering an image in the non-editable video material to obtain an intermediate texture, the method further comprises: caching the intermediate texture.

15. The electronic device according to claim 14, wherein a method of rendering the updated preview image, comprises:
reading the cached intermediate texture, and obtaining an updated image of the to-be-edited video material; and
based on a rendering sequence of the updated image of the to-be-edited video material and the intermediate texture, rendering the updated image of the to-be-edited video material and the intermediate texture in sequence to obtain the updated preview image.

16. The electronic device according to claim 15, wherein the rendering sequence of the updated image of the to-be-edited video material and the intermediate texture is determined based on information of a layer on which the to-be-edited video material is located and information of a layer on which the non-editable video material is located.

17. The electronic device according to claim 15, wherein images of the plurality of video materials are rendered on a canvas; and
before rendering the updated image of the to-be-edited video material and the intermediate texture in sequence, the method further comprises: clearing the canvas.

18. The electronic device according to claim 11, wherein the video editing page further comprises a track display area, the track display area comprises a plurality of editing tracks, and the plurality of editing tracks respectively correspond to the plurality of video materials;
the selection operation comprises at least one selected from the group consisting of:
a selection operation on an image of at least one video material in the preview image in the preview area; and
a selection operation on at least one editing track in the track display area; and
a video material corresponding to the selected image or the selected editing track is the to-be-edited video material, and a video material except the to-be-edited video material is the non-editable video material.

19. The electronic device according to claim 11, wherein the video editing page further comprises an attribute setting area, and the attribute setting area comprises a plurality of attribute setting controls; and
the editing operation comprises at least one selected from the group consisting of:
a first editing operation on an image of the to-be-edited video material in the preview area; and
a second editing operation on any attribute setting control in the attribute setting area.

20. A non-transitory storage medium comprising a computer-executable instruction, wherein the computer-executable instruction is executed by a computer processor to implement a method for rendering, wherein the method comprises:
displaying a video editing page, wherein the video editing page comprises a preview area, and a preview image formed by a plurality of video materials is displayed in the preview area;
in response to a selection operation on the video editing page, determining a to-be-edited video material and a non-editable video material; and rendering an image in the non-editable video material to obtain an intermediate texture; and
in response to an editing operation on the to-be-edited video material, displaying an updated preview image in the preview area, wherein the updated preview image is obtained by synthesizing and rendering based on the intermediate texture and the updated image of the to-be-edited video material, and the editing operation is used for updating a display state of the image in the to-be-edited video material to obtain the updated image.
